(19) United States
(12) Patent Application Publication
(10) Pub. No.: US 2008/0008102 A1
(43) Pub. Date: Jan. 10, 2008

(54) Tracing an optical path of a communication network

(75) Inventors: Snigdho C. Bardalai, Plano, TX (US); Richard J. Dunsmore, McKinney, TX (US)

Correspondence Address: BAKER BOTTS L.L.P., 2001 ROSS AVENUE, SUITE 600, DALLAS, TX, 75201-2980, US

(73) Assignee: Fujitsu Limited

(21) Appl. No.: 11/482,619

(22) Filed: Jul. 7, 2006

(51) Int. Cl. H04J 3/14

(52) U.S. Cl. 370/242; 370/389

(57) ABSTRACT

Tracing a path of a communication network includes sending a path message through a sequence of nodes in response to receiving a notification of a networking problem. The sequence comprises an initiating node, a set of intermediate nodes, and a terminating node. The following is repeated for each intermediate node: establishing a next intermediate node subsequent to an intermediate node, and gathering path information about the next intermediate node in the path message. The path message is received at the terminating node, and the path information is recorded in a return message. At least one node of the sequence of nodes affected by the networking problem is identified.

### TECHNICAL FIELD

This invention relates generally to the field of communication networks and more specifically to tracing an optical path of a communication network.

### BACKGROUND

Network troubleshooting includes detecting and diagnosing networking problems of a communication network. Typically, troubleshooting involves identifying nodes of the network affected by the problems. The nodes may be identified by tracing the paths through the nodes.

Known techniques of network troubleshooting include communicating protocol messages to detect nodes that are having difficulties sending and/or receiving messages. Other known techniques of network troubleshooting include inserting trace messages into packets to detect nodes having such difficulties. These known techniques, however, may not be efficient in certain situations. It is generally desirable to have efficient techniques for network troubleshooting.

### SUMMARY OF THE DISCLOSURE

In accordance with the present invention, disadvantages and problems associated with previous techniques for network troubleshooting may be reduced or eliminated.

According to one embodiment of the present invention, tracing a path of a communication network includes sending a path message through a sequence of nodes in response to receiving a notification of a networking problem. The sequence comprises an initiating node, a set of intermediate nodes, and a terminating node. The following is repeated for each intermediate node: establishing a next intermediate node subsequent to an intermediate node, and gathering path information about the next intermediate node in the path message. The path message is received at the terminating node, and the path information is recorded in a return message. At least one node of the sequence of nodes affected by the networking problem is identified.

Certain embodiments of the invention may provide one or more technical advantages. A technical advantage of one embodiment may be that optical paths of a network may be traced by gathering path information describing the paths. The path information may be gathered by a path message sent through the control plane. Using such a path message may provide for more efficient gathering of path information.

A technical advantage of another embodiment may be that the path information may be gathered from management plane information stored at the nodes, and may be used to generate control plane information. Generating control plane information from management plane information may provide for migration from management plane to control plane. A technical advantage of another embodiment may be that the gathered path information may include monitoring information. Gathering the monitoring information may allow the network to be monitored while the paths are being traced.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a network system for which optical paths may be traced in a troubleshooting operation according to one embodiment;

FIG. 2 is a flowchart illustrating one embodiment of a method of tracing an optical path that may be used with the network system of FIG. 1; and

FIG. 3 is a diagram illustrating creation of path information for multicast paths.

### DETAILED DESCRIPTION OF THE DRAWINGS

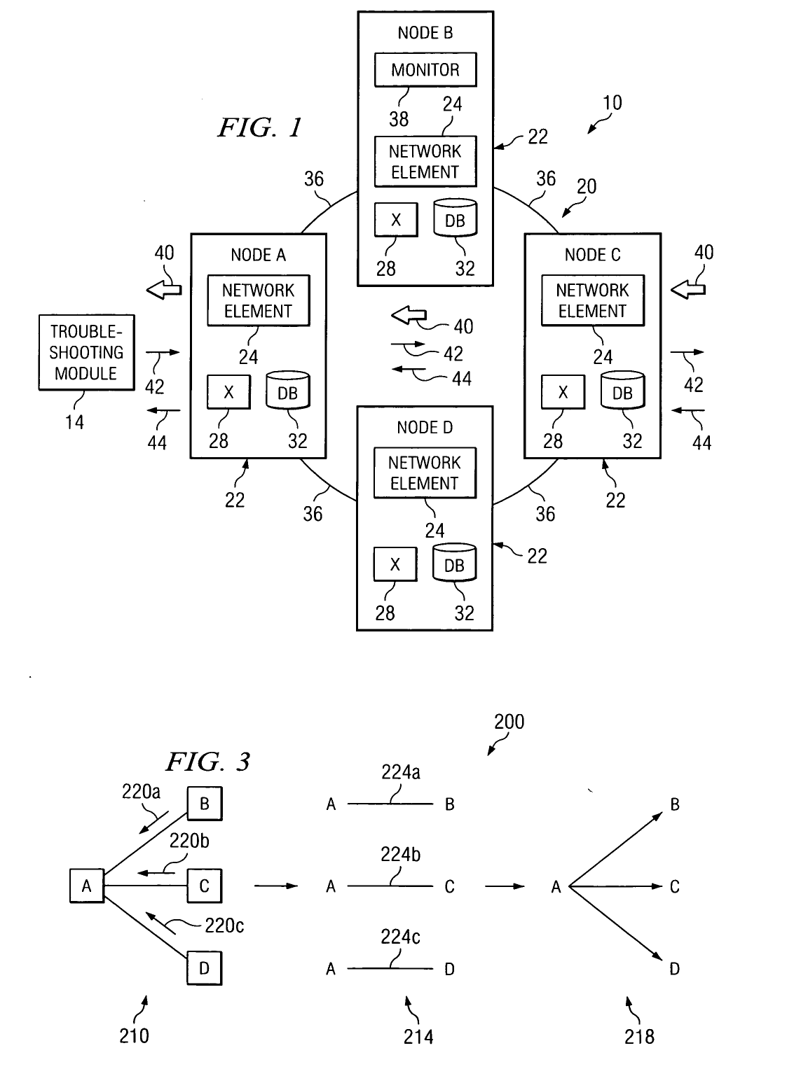

Embodiments of the present invention and its advantages are best understood by referring to FIGS. 1 through 3 of the drawings, like numerals being used for like and corresponding parts of the various drawings.

FIG. 1 is a block diagram illustrating a network system 10 for which optical paths may be traced in a troubleshooting operation according to one embodiment. According to the embodiment, tracing the optical paths may involve gathering path information describing the paths. The path information may be gathered using a path message sent through the control plane. The path information may then be used to identify nodes affected by a networking problem.

System 10 includes components such as devices. In general, a device may include any suitable arrangement of components operable to perform the operations of the device. As an example, a device may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Network system 10 communicates information through signals. A signal may refer to an optical signal transmitted as light pulses. As an example, an optical signal may have a frequency of approximately 1550 nanometers and a data rate of 10, 20, 40, or over 40 gigabits per second. A signal may comprise a synchronous transport signal (STS).

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, control, signaling, other information, or any combination of the preceding. The packets may comprise any suitable multiplexed packets, such as time division multiplexed (TDM) packets.

According to the illustrated embodiment, network system 10 includes a troubleshooting module 14 coupled to one or more ring networks 20 that each include nodes 22. Troubleshooting module 14 may perform a troubleshooting operation that detects and diagnoses networking problems of ring network 20.

The troubleshooting operation may be initiated in response to receiving a notification of a problem. A notification may comprise, for example, a customer complaint, an alarm generated by a node of ring network 20, or other notification indicating that a problem of ring network 20 has been detected. In one embodiment, a user may receive a notification of a problem and then may prompt troubleshooting module 14 initiate the troubleshooting operation. In another embodiment, troubleshooting module 16 may automatically initiate the troubleshooting operation in response to receiving a notification.

Troubleshooting module 14 may identify nodes 22 affected by a networking problem. An affected node 22 may refer to a node 22 that has its operation affected by, such as disrupted by, the networking problem. Troubleshooting module 14 may then diagnose the problem and provide instructions for resolving or dealing with the problem.

A ring network 20 may include nodes 22 coupled by fibers 26 in a ring topology. Ring network 20 may have any suitable topology, for example, a unidirectional path-switched ring (UPSR) topology or a bidirectional line switched ring (BLSR) topology. According to one embodiment, ring network 20 may comprise an optical fiber ring.

Ring network 20 may utilize protocols such as Resilient Packet Ring (RPR) protocols. An RPR protocol may refer to a protocol for ring-based packet transport, where packets are added, passed through, or dropped at each node 22. According to one embodiment, ring network 20 may utilize any suitable transmission technique, such as Ethernet, Synchronous Optical Network (SONET), or wavelength division multiplexing (WDM) (such as dense wavelength division multiplexing (DWDM)) techniques.

A node 22 routes a packet to a next node 22 of a path according to the destination address of the packet. Typically, the destination address specifies a node identifier, such as an Internet Protocol (IP) address, that uniquely identifies a destination node 22. A node 22 may have a table that specifies an output port for a given destination address.

A path, or circuit, may refer to a sequence of nodes 22 comprising endpoint nodes 22 and a set of zero or more intermediate nodes 22 between the endpoint nodes 22. Endpoint nodes 22 may include an initiating node 22 and a terminating node 22. An initiating node 22 may refer to a node 22 at which a message enters network system 10, and a terminating node 22 may refer to a node 22 at which the message exits network system 10. Accordingly, a message may travel from an initiating node 22, through the zero or more intermediate nodes 22, to a terminating node 22. Example path types include unidirectional, bidirectional, drop and continue, broadcast, or multicast path types.

An endpoint node 22 may be identified in any suitable manner. According to one embodiment, a node 22 may be identified as an endpoint node 22 if the node 22 is a network facility, if the node 22 comprises a WDM interface that has no neighbor node 22, or if the node 22 does not have a provisioned cross connect 28.

Traffic 40 may travel in a particular direction of a path. According to the illustrated example, traffic 40 flows from node C through node B to node A. A traffic ingress node 22 may refer to a node 22 at which traffic enters network system 10, and a traffic egress node 22 may refer to a node 22 at which the traffic exits network system 10. Packets may travel in a direction that is reverse of the direction of traffic. A reverse traffic ingress node 22 may refer to a node 22 at which a reverse packet enters network system 10, and a reverse traffic egress node 22 may refer to a node 22 at which the reverse packet exits network system 10.

Path information may refer to information describing one or more paths. As an example, path information may include the sequence of nodes 22 included in a path. According to one embodiment, path information may also include monitoring information. Monitoring information may refer to information that may be used to monitor network system 10. Monitoring information may include, for example, information describing the performance and condition of network system 10, such as the optimal power level for a specific wavelength, the error count per path, or the alarm information for a link of a path.

According to one embodiment, paths may be monitored from endpoint to endpoint while paths are being traced. The monitoring information may be gathered in response to a request to collect the monitoring information. According to the embodiment, the monitoring information may be gathered each time path information is collected or only certain times when path information is collected.

A node 22 may include any suitable device. According to the illustrated embodiment, a node 22 includes a network element 24, a cross connect 28, and a database 32. A network element 24 may include any suitable device operable to route packets to or from ring network 20. Examples of network elements 24 include dense wavelength division multiplexers (DWDMs), access gateways, endpoints, softswitch servers, trunk gateways, access service providers, Internet service providers, or other device operable to route packets to or from ring network 20.

A cross connect 28 may comprise a coupling device that couples connecting hardware on each end. According to one embodiment, fiber patch cords may be used to make the circuit connections. Cross connect 28 may be incorporated with or separate from network element 24.

According to one embodiment, cross connect 28 may include information generated at the management plane that may be used to generate the path information. In the embodiment, cross connect 28 may map a specific input port to a specific output port such that a packet received at the input port is routed to the output port. The mappings from cross connects 28 of an optical may be used to generate path information describing the path, which may provide control plane information to manage the paths end-to-end. Accordingly, the management plane information may be used to provide control plane information.

A database 32 may comprise a device operable to store link state information, for example, a link state database (LSDB). Link state information describes the links and paths of network system 10.

According to one embodiment, a node 22 may include a monitor 38. Monitor 38 may be used to monitor a path message as it collects path information. According to one embodiment, monitor 38 may include a graphical user interface that displays trace values at intermediate nodes 22.

Fibers 36 may refer to any suitable fiber operable to transmit a signal. According to one embodiment, a fiber 36 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber.

A ring network 20 may have any suitable number of fibers 36, for example, two fibers 36. As an example, the first fiber 36 traverses a ring network 20 in one direction, and the second fiber traverses ring network 20 in the other direction. A ring segment may refer to the portion of fibers 36 between network elements 24, and may be designated by the specific ports of network elements coupled by the ring segment.

According to one embodiment of operation, tracing optical paths may involve gathering path information describing the optical paths of network system 10. The path information may be gathered by a path message 42. Path message 42 may be sent using out-of-band signals over the control plane.

Path message 42 may be sent from an initiating node 22, through zero or more intermediate nodes 22, to a terminating node 22. Path message 42 may travel in any suitable direction through nodes 22, for example, in the direction of the flow of traffic 40 or opposite to the direction of the flow of traffic 40. According to one embodiment, a path message 42 travels in a direction opposite the flow of traffic 40. That is, path message 42 may be sent from a reverse ingress node 22, through one or more intermediate nodes 22, to a reverse egress node 22.

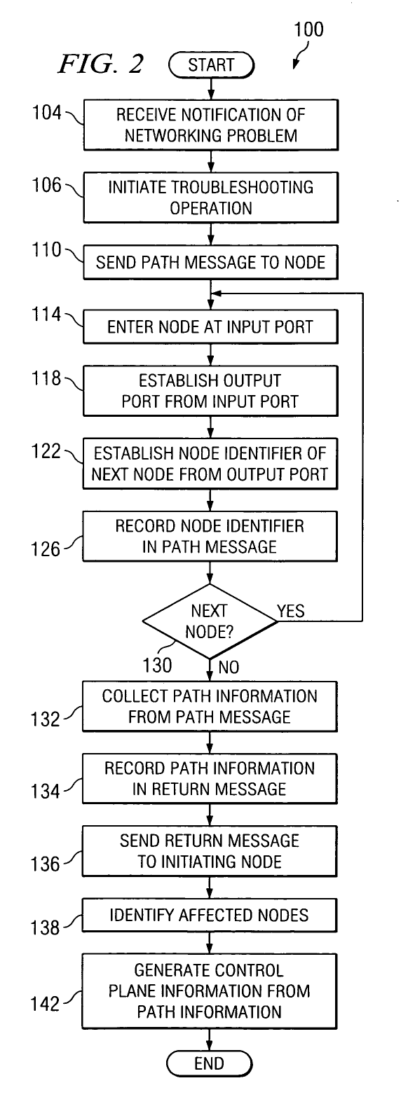

Path message 42 gathers path information as it passes through nodes 22 from an initiating node 22 to a terminating node 22. The path information may be gathered according to any suitable method. An example method is described with reference to FIG. 2. Terminating node 22 collects the gathered path information, and sends the path information back to initiating node 22 in a return message 44. The path information may be stored at databases 32 of initiating node 22.

In one example, the path and return messages may perform other operations in addition to gathering path information. In the example, the path and return messages may be used to reserve resources, for example, bandwidth. For example, the path message may comprise an RSVP path message, and the return message may comprise an RSVP reservation-request message.

In the example, the path messages may describe requested resources, for example, bandwidth requirements and parameters of data to be sent. The path messages are propagated from an initiating node 22 through intermediate nodes 22 to terminating nodes 22. Each terminating node 22 interested in the data confirms the flow by sending a reservation-request message through the network. The reservation-request message describes the bandwidth characteristics of the data to be received from the initiating node 22. As the reservation-request messages propagate back towards the initiating node 22, intermediate nodes 22 determine whether or not to accept the proposed reservation and commit resources based on their capacity. If an intermediate node 22 decides to accept the proposed reservation, the resources are committed and the reservation-request message is propagated to a next node 22 in the path.

Modifications, additions, or omissions may be made to network system 10 without departing from the scope of the invention. The components of network system 10 may be integrated or separated according to particular needs. Moreover, the operations of network system 10 may be performed by more, fewer, or other devices. Additionally, operations of network system 10 may be performed using any suitable logic. As used in this document, “each” refers to each member of a set or each member of a subset of a set.

FIG. 2 is a flowchart illustrating one embodiment of a method of tracing an optical path that may be used with network system 10 of FIG. 1. The method begins at step 104, where notification of a network problem is received. The notification may be received at troubleshooting module 14. A troubleshooting operation is initiated at step 106 in response to receiving the notification.

Path message 42 is sent to a node 22 of network system 10 at step 110. Node 22 may be an initiating node 22. If path message 42 is traveling against the flow of traffic 40, node 22 may comprise a reverse ingress node 22. Path message 42 may comprise, for example, an RSVP path message. If a destination address is needed in the path message, a random destination address may be supplied, and the path message may be allowed to terminate at an arbitrary node 22. As an example, the path message may be allowed to terminate at a terminating cross connect 28. According to one embodiment, a path message may be distinguished from a regular connection message by a marker identifying the path message.

Path message 42 enters node 22 at an input port of node 22 at step 114. An output port is established from the input port at step 118. A cross connect 28 of node 22 may specify a particular output port for a given input port. A node identifier of a next node 22 is established at step 122. A network element 24 may map a node identifier to an output port. From this mapping, a node identifier may be established from a given output port. The node identifier is recorded in the path message at step 126. According to one embodiment, the hop may be recorded by recording an explicit route (ERO).

The current node 22 may be a terminating node 22 or a node 22 experiencing a network problem. According to one embodiment, a next hop routing (NHR) step may have a flag to inform a core RSVP stack that the current node 22 is a terminating node. If the current node 22 is not a terminating node 22, there may be a next node 22 of the path at step 130. If there is a next node 22, the method returns to step 114, where the path message enters an input port of the next node 22. If there is no next node at step 130, the method proceeds to step 132.

Path information is collected from the path message at step 132. The path information includes the node identifiers of the nodes 22 in the path traveled by the path message. The path information is recorded in a return message at step 134. The return message may comprise an RSVP reservation-request message. The return message is sent to the initiating node 22 at step 136.

A node 22 affected by the networking problem is identified at step 138. An affected node 22 may refer to a node 22 that has its operation affected by, such as disrupted by, the networking problem. The affected nodes may be identified by comparing node identifier information obtained by the response with the list of network problem notification reports. This step may be used to correlate the traced path and the network problem.

Control plane information is generated from the path information at step 142. The control plane information may be generated by creating a control plane state for the path and then associating the path information with the control plane state. After generating the control plane information, the method terminates.

Modifications, additions, or omissions may be made to the method without departing from the scope of the invention. The method may include more, fewer, or other steps. Additionally, steps may be performed in any suitable order without departing from the scope of the invention.

FIG. 3 is a diagram 200 illustrating creation of path information for multicast paths. According to diagram 200, node A multicasts streams to nodes B, C, and D. Diagram 20 illustrates steps 210, 214, and 218 for generating the path information. Path messages are sent from nodes B, C, and D to node A against the direction of traffic at step 210. Path message 220a is sent from node B, path message 220b is sent from node C, and path message 220c is sent from node D.

Path messages 220 record the paths at step 214. Path message 220a records path 224a between nodes A and B, path message 220b records path 224b between nodes A and C, and path message 220c records path 224c between nodes A and D. The paths are merged according to common nodes at step 218. Paths 224a, 224b, and 224c have node A in common. Accordingly, paths 224 are merged to indicate that node A multicasts to nodes B, C, and D.

According to another embodiment, path messages 220 are be sent in the direction of traffic, instead of against the direction of traffic. When a path splits into several branches, the session may be split to multiple sessions, one session for each branch.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that optical paths of a network may be traced by gathering path information describing the paths. The path information may be gathered by a path message sent through the control plane. Using such a path message may provide for more efficient gathering of path information.

A technical advantage of another embodiment may be that the path information may be gathered from management plane information stored at the nodes, and may be used to generate control plane information. Generating control plane information from management plane information may provide for migration from management plane to control plane. A technical advantage of another embodiment may be that the gathered path information may include monitoring information. Gathering the monitoring information may allow the network to be monitored while the paths are being traced.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for tracing a path of a network, comprising:
sending a path message through a sequence of nodes of a communication network in response to receiving a notification of a networking problem, the sequence of nodes comprising an initiating node, a set of intermediate nodes, and a terminating node, the path message sent from the initiating node, through the set of intermediate nodes, to the terminating node;
repeating the following for each intermediate node of the set of intermediate nodes:
establishing a next intermediate node subsequent to the each intermediate node; and
gathering path information about the next intermediate node in the path message;
receiving the path message at the terminating node;
recording the path information in a return message; and
identifying at least one node of the sequence of nodes affected by the networking problem.

2. The method of claim 1, wherein:
the path message comprises a Resource Reservation Protocol (RSVP) path message; and
the return message comprises an RSVP reservation-request message.

3. The method of claim 1, wherein sending the path message through the sequence of nodes of the communication network further comprises:
sending the path message using an out-of-band signal over a control plane.

4. The method of claim 1, further comprising:
recording the path information.

5. The method of claim 1, wherein establishing the next intermediate node subsequent to the each intermediate node further comprises:
establishing the next intermediate node subsequent to the each intermediate node according to management plane information.

6. The method of claim 1, wherein establishing the next intermediate node subsequent to the each intermediate node further comprises:
establishing an output port of a cross connect at the each intermediate node, the output port mapped to an input port of the cross connect, the input port used by the path message; and
determining the next intermediate node from the output port.

7. The method of claim 1, wherein establishing the next intermediate node subsequent to the each intermediate node further comprises:
establishing an output port corresponding to a destination address of the path message; and
determining the next intermediate node from the output port.

8. The method of claim 1, wherein the path information comprises monitoring information.

9. The method of claim 1, further comprising:
initiating a troubleshooting operation.

10. A system operable to trace an optical path, comprising:
a troubleshooting module operable to:
send a path message through a sequence of nodes of a communication network in response to receiving a notification of a networking problem, the sequence of nodes comprising an initiating node, a set of intermediate nodes, and a terminating node, the path message sent from the initiating node, through the set of intermediate nodes, to the terminating node, the path message operable to gather path information about a next intermediate node subsequent to each intermediate node;
receive a return message from the terminating node, the terminating node operable to record the path information in the return message; and
identify at least one node of the sequence of nodes affected by the networking problem.

11. The system of claim 10, wherein:
the path message comprises a Resource Reservation Protocol (RSVP) path message; and
the return message comprises an RSVP reservation-request message.

12. The system of claim 10, wherein the troubleshooting module is operable to send the path message through the sequence of nodes of the communication network by:
sending the path message using an out-of-band signal over a control plane.

13. The system of claim 10, where the troubleshooting module is operable to:
record the path information at the troubleshooting module.

14. The system of claim 10, wherein the next intermediate node subsequent to the each intermediate node is established according to management plane information.

15. The system of claim 10, wherein the next intermediate node subsequent to the each intermediate node is established by:
establishing an output port of a cross connect at the each intermediate node, the output port mapped to an input port of the cross connect, the input port used by the path message; and
determining the next intermediate node from the output port.

16. The system of claim 10, wherein the next intermediate node subsequent to the each intermediate node is established by:
establishing an output port corresponding to a destination address of the path message; and
determining the next intermediate node from the output port.

17. The system of claim 10, wherein the path information comprises monitoring information.

18. The system of claim 10, wherein the troubleshooting module is operable to:
initiate a troubleshooting operation.

19. A system for tracing a path of a network, comprising:
means for sending a path message through a sequence of nodes of a communication network in response to receiving a notification of a networking problem, the sequence of nodes comprising an initiating node, a set of intermediate nodes, and a terminating node, the path message sent from the initiating node, through the set of intermediate nodes, to the terminating node;
means for repeating the following for each intermediate node of the set of intermediate nodes:
establishing a next intermediate node subsequent to the each intermediate node; and
gathering path information about the next intermediate node in the path message;
means for receiving the path message at the terminating node;
means for recording the path information in a return message; and
means for identifying at least one node of the sequence of nodes affected by the networking problem.

20. A method for tracing a path of a network, comprising:
sending a path message through a sequence of nodes of a communication network in response to receiving a notification of a networking problem, the sequence of nodes comprising an initiating node, a set of intermediate nodes, and a terminating node, the path message sent from the initiating node, through the set of intermediate nodes, to the terminating node, the path message comprising a Resource Reservation Protocol (RSVP) path message, the path message sent using an out-of-band signal over a control plane;
repeating the following for each intermediate node of the set of intermediate nodes:
establishing a next intermediate node subsequent to the each intermediate node, establishing the next intermediate node subsequent to the each intermediate node according to management plane information further comprising:
establishing an output port of a cross connect at the each intermediate node, the output port mapped to an input port of the cross connect, the input port used by the path message;
establishing the output port corresponding to a destination address of the path message; and
determining the next intermediate node from the output port; and
gathering path information about the next intermediate node in the path message, the path information comprises monitoring information;
receiving the path message at the terminating node;
recording the path information in a return message, the return message comprising an RSVP reservation-request message;
recording the path information;
identifying at least one node of the sequence of nodes affected by the networking problem; and
initiating a troubleshooting operation.
